(19) United States
(12) Patent Application Publication
(10) Pub. No.: US 2006/0235855 A1
(43) Pub. Date: Oct. 19, 2006

(54) Digital library system

(76) Inventors: David Nicholas Rousseau, Addlestone (GB); Julie Anne Rousseau, Addlestone (GB)

Correspondence Address: DAVID A. GUERRA;INTERNATION PATENT GROUP, LLC, 10TH FLOOR, 610 8TH AVENUE S.W., CALGARY, AB, T2P 1G5, CA

(21) Appl. No.: 10/554,965

(22) PCT Filed: May 4, 2004
(86) PCT No.: PCT/GB04/01912

§ 371 Date: Oct. 28, 2005

(30) Foreign Application Priority Data
May 2, 2003 (GB) 0310218.3

(51) Int. Cl. G06F 7/00

(52) U.S. Cl. 707/100

(57) ABSTRACT

An apparatus and method for setting up and operating a digital multi-media library configured in such as way as to enable the creation of custom sub-libraries. In this system users are able to create private themed sub-libraries that contain information assets that are excerpts of the main library's information assets. This is accomplished via a special proxy asset structure. The apparatus and method further enables, via use of the custom library feature and the special proxy asset structure, the deployment of digital libraries more quickly than current methods allow, and in a manner that spreads more of the set-up cost into the post-deployment period.

### FIELD OF THE INVENTION

The present invention relates to an apparatus and method for setting up and operating a digital library. More particularly, it relates to a system configured in such as way as to enable the creation of custom sub-libraries. It further relates to a method and system using custom sub-libraries to improve the cost-effectiveness of providing a digital library.

### BACKGROUND OF THE INVENTION

A digital library may be defined as a focused collection of digital information assets, including text, video and audio, along with computer-based processes enabling access and retrieval as well as selection, organisation, and maintenance of the collection (see Witten and Bainbridge, How to Build a Digital Library, Morgan Kaufmann Publishers, 2003).

Digital libraries can exist not only as stand-alone or networked libraries but also as components of more extensive digital information systems such as enterprise content management systems and digital publishing systems. These extended systems support additional processes related to the creation, use, version control, sharing and distribution (including sale) of information assets.

There is an increasing demand for organisations, companies and publishers to create digital libraries to hold their Information assets so that they can take advantage of the benefits digital libraries bring, amongst others cost reduction, improved response times and extended geographical range of operational communities.

Furthermore, benchmarking surveys indicate that employees spend up to 40% of their time locating information they need to do their work. Digital libraries enable companies to eliminate this waste as well as to ensure the security, integrity and persistence of their information assets. By integrating digital libraries into extended digital information systems companies are able to improve the effectiveness and efficiency of Information-dependent business processes by reducing their cycle time and cost and by increasing their consistency and security. The ability to share the use of such systems over wide area networks (WANs) enables companies to extend the geographical range of their operations without sacrificing process discipline, response time or information consistency. The demand for and utility of digital libraries and the systems that incorporate them or interact with them has increased in line with the development of the Internet, the increased power of computing devices, the availability of mobile computing and the falling cost of data storage.

The building of a digital library is a specialist task requiring specialist tools, methods and expertise. In practise the cost and time required to build a basic digital library generally increases linearly with the quantity of source material to be digitised. Furthermore, the versatility of the digital library is dependent on the way the data is organised and the amount of descriptive metadata that is included or catered for. The cost of creating digital libraries with complex data structures and rich metadata generally increases exponentially with the quantity of the source material to be included, as cross-references and other links internal to the data need to be maintained.

Although several commercial systems exist that support different parts of the building and deployment of digital libraries, the costs remain high enough to often put the building of a digital library beyond the means of organisations that have low income, limited reserves or a large body of material to be digitised and indexed. Alternatively, such organisations may develop libraries with reduced functionality.

The building of a digital library minimally requires the generation of digital information assets and descriptive metadata. This process is time-consuming and therefore very expensive. Typically, the process requires that physical information assets be converted into digital equivalents. For example, in the case of a digital document library deploying information assets such as books or journal volumes, the physical pages of each physical volume have to be scanned one by one using a digital scanner. In order to preserve the logical structure of the original asset, for example the articles in a journal volume, the scanning has to be performed in logical batches, and to make that possible the physical asset has to be either disassembled into logical batches or the logical breaks have to be marked up by physical means such as barcode labels. This is a labour-intensive process. In addition, data that describe each logical part have to be keyed into the digital library database so that each digital asset can be correctly identified and located in the future. If the full text is to be made searchable, then the digital page images have to be converted into electronic text, typically via the use of optical character recognition (OCR) software.

Apart from the labour cost these processes incur, every logical class of legacy asset has to be completely digitised, indexed, described and loaded before the digital library can be deployed, since a search on partial information yields results with poor utility and does not remove the requirement to search the legacy source. In consequence, digital libraries typically require a high level of investment before any operational benefit is achieved. It would be an advantage if systems could be set up in such a way that deployment timescales could be reduced. It would also be an advantage if systems could be set up and used in a way that allows some of the cost of building the digital library to be deferred to a time when the library is already providing a benefit to its users or owners (especially as these benefits may include an operational cost saving or an income opportunity).

A further problem of digital libraries is that some logical information assets can be very large data objects, for instance an electronic book can run to hundreds or thousands of pages. Handling such large objects constrains the performance of the system, e.g. it can take a long time to retrieve a large document over a network link. A user who is only interested in a small portion of the information in a large data object may still be required to retrieve the complete object, thus taxing system resources unnecessarily. It would be an advantage if the digital library could be set up in such a way that large information assets could be handled without limiting system performance or degrading the user experience.

A further problem arises when the information assets contain several different logical structures, for example, Journals might contain both articles and correspondence. These different structures require the underlying data storage to be segmented in an analogous way (e.g. by having separate database tables). Such data cannot be integrated. When the library is being built, separate processing, loading and maintenance tools must be created for each type of data with unique logical structure. Separate user interfaces are required for searching each type of logical asset. The overhead this represents in set-up cost and operational complexity often leads to compromises where the primary sections of an information source are digitised while sections of secondary importance may be discarded (e.g. journal articles are included but correspondence is not). It would be an advantage if the information assets could be represented in a way that allows all logical structures to be handled in a common way, both in system set-up and in system usage.

Given the high cost and long timescales involved in creating even a simple digital library, creating a digital library that has a complex data structure or rich metadata is rarely affordable. The low basic cost and high computational power of the infrastructure make many features possible in principle that cannot be realised in practise due to the high cost of creating the necessary base content and descriptive metadata. For example, it is possible in principle for a digital library to enable the information assets to be dynamically reorganised according to different organisational schemes, as long as the different organisational schemes have been predefined and the information assets referenced within each scheme. This could allow powerful searching, for example browsing through a hierarchy of associated keyword-based classes would be proof against changes in the terminology used in the actual textual content. However, the cost and time required to create such rich metadata is generally prohibitive, especially as the number of ways in which data can potentially be classified and organised is nearly infinite. Moreover, to be effective, such metadata has to characterise the information content at a low level of granularity. The lower this level is, the higher the investment required to create this metadata. It would be an advantage if the flexibility of digital libraries could be increased in such a way as to accommodate different user's needs for different organisational schemes while avoiding the usual penalty in cost and timescales.

Several systems and technologies have been developed in response to some of these known problems.

Many systems exist that automate aspects of the creation of digital equivalents of paper-based information assets. Scanners such as Canon's DR5020 or Kodak's 9520 scanner allow fast double-sided scanning of stacks of pages. Software products such as Adobe's Capture or ABBYY's FineReader allow the output of such scanners to be captured as single multi-page documents or a sequence of single-page documents, and enable these documents to be stored in a variety of formats (e.g. an image format such as TIF or a formatted text format such as HTML, the latter being generated via embedded OCR software). However, these systems do not eliminate the requirement to separate or mark up the source material into logical sections.

Several methods for splitting large digital objects into meaningful smaller ones are known outside of the context of digital libraries. For example, in US 2002/0184188 Mandyam et al disclose a method for extracting content from a document using rules that refer to code structures within the document (e.g. XML tags), and in U.S. Pat. No. 6,370,553 Edwards et al disclose a method for creating subdocuments with active properties that enable subsequent association or reintegration of the subdocuments while component documents can be handled as documents in their own right. Such methods as these are commonly available in applications that allow editing or creation of new information assets as part of the process of building a library, preparing material for publishing or broadcasting, or creating low-level metadata for large or complex information assets. However, these methods still require some prior mark-up of the source material into logical sections.

In US 2003/0028503 Guiffrida et al disclose a method and system for automatically extracting metadata from electronic documents using spatial and semantic analysis. Although such techniques could be used (at least in principle) to break a data-stream into logical sections, such systems would be ineffective when the data-stream consists of assets with varying logical structure.

Software products such as Captiva's InputAccel or ReadSoft's Eyes & Hands enable capture of asset metadata from pre-defined areas of a scanned page. This is effective for documents such as forms that have a consistent structure, but less appropriate for variable material. These systems usually provide additional tools that allow posting of captured metadata (including the entire OCR text) directly into the repository of a digital Information system (e.g. Opentext's Livelink or Documentum's Documentum 5). This posted metadata is then used as information on which to search or otherwise act, while the original linked document image file is retrieved for display.

Many examples exist of systems using such metadata as indexes for scanned image files. In US 2002/0083090 Jeffrey et al disclose a system for doing this in relation to a legal contracts library, and in US 2002/0176628 Starkweather discloses a system for doing this without requiring an underlying database.

Since the effectiveness of such searches is limited by the accuracy of the metadata capture processes, it is normal for such data capture systems to provide a forms-based graphical user interface for verification of OCR accuracy, formatting, data type casting, and so forth, before the text is posted to the database. Such set-ups, though effective, require each document page to be manually verified before storage, which is very time-consuming. This methodology generally does not take account of the increasing quality of digital scanning optics and the increasing intelligence of optical character recognition software. Even if the automated processing has an accuracy of near 100%, this verification step is required before the data is posted to the repository. Systems such as Documentum 5 alleviate this problem by applying artificial intelligence (AI) methods involving semantic and syntactic analysis of the OCR text, and thereby reduce the amount of manual inspection required. Unfortunately, these high-end systems are very expensive to purchase and still require considerable effort in the configuring and training of the AI subsystem. These solutions all require a substantial Investment of resources in the period before the digital assets can be made available to library users.

Several solutions have been developed to ease the problem of handling large data objects. In US 5,857,204 Kauffman et al disclose a system for breaking up large documents into smaller files of variable length to enable transfer and processing without exceeding the system's memory capacity, followed by reassembly of the document when the transfer is complete. Such methods increase the reliability of systems that handle large digital objects but they do not reduce the time taken to process or transfer a large document. In addition, they do not alleviate the system performance tax associated with handling large objects that exceed in content the information requirement of the user concerned. Several systems exist that manage large objects via Adobe's portable document format (PDF) coupled with their Acrobat Reader, a viewer for PDF documents. These systems use a content server to split up the PDF data-stream Into pages (using the document's internal page-break tags), allowing the user to view one page at a time. This is a great help when viewing documents of many pages, as the user does not have to wait for the whole document to be transferred to the client workstation before the content viewing can begin. However, once the user has Identified the material required, the whole document has to be downloaded as a single file (even if only a small portion Is wanted), or the required portion has to be saved page-wise as a series of disjunct files (which can be tedious if the requirement is for e.g. 50 pages from a 3,000 page document).

Several inventors have noted that browsing on categories is a powerful alternative to string-searching textual content, especially where there is uncertainty about the terminology or context that applies to the information being sought. In U.S. Pat. No. 6,112,201 Wical discloses a system that provides dynamic hierarchical browsing of a library's content. In U.S. Pat. No. 5,920,864 Zhao discloses a related method. These methods require a full categorisation of the data source to be effective. The cost of defining such taxonomies and of classifying each information asset can be excessive. In addition, every time a taxonomy is updated all information assets may have to be reconsidered, which makes taxonomy maintenance very labour intensive; this problem would exist for every taxonomy applied to the information asset set. To be effective, such taxonomies have to be applied to a data source at a high resolution, further increasing the cost.

In practice, what such taxonomies achieve is to provide the user with the ability to locate a themed collection of information assets, disregarding the logical structure of the library. On this view, several inventors have considered ways of creating custom sub-libraries that are made to purpose for a specific interest group. While less immediate than using an exhaustive preloaded classification system, it is a less expensive approach. In U.S. Pat. No. 7,778,366. Gillihan et al disclose a system where a librarian can create a virtual (themed) bookshelf by collating a number of information assets into a special list that can be made available to a designated group of users. In WO 00/02143 Fox et al, and in US 2002/0087944 David disclose methods for creating custom collections by making local copies of remote data sources and keeping them synchronised with their remote sources. In WO 02/093418 Viswanathan et al disclose a method for assigning a relevance rank to each item in the custom library, allowing large custom libraries to be managed. These custom library solutions suffer from a number of deficits. Generally, they have to be carefully pre-prepared by specialist librarians, rather than being created “on-the-fly” as and when needed. Furthermore, the digital assets that appear in such themed collections are still the whole logical objects of the source library. The methods for splitting documents into smaller sections as referenced earlier are designed for use by those preparing digital libraries. They are not available to the end users of a library (even a custom library), therefore from an end user's perspective the library assets have to be used in the format in which they were prepared by the provider.

There is therefore a widely recognised need for, and it would be advantageous to have, a system and method that would enable digital libraries to be built and used in a way that:
reduces the deployment timescales, and/or
allows some of the cost of building the digital library to be incurred in the post-deployment period, and/or
allows handling of large information assets without degrading the user efficiency, and/or
allows multiple kinds of logical data structures to be handled in a common way, and/or
flexibly accommodates different users' needs for different organisational schemes without escalating the system cost

### SUMMARY OF THE INVENTION

It is an object of the invention to alleviate the problems of the prior art arrangements.

A first aspect of the present invention is an apparatus configured to operate as a digital library for enabling access to information assets, the apparatus incorporating:
a) a structuring part that provides means for representing any information asset of the library with a collection of one or more proxy assets, where the or each proxy asset consists of metadata that describes and references a data portion or an ordered plurality of data portions, where each data portion contains part of the information content of the information asset being represented; and
b) a sectioning part that provides means for creating new proxy assets such that each new proxy asset references one or several of the data portions referenced by a given proxy asset.

Preferably, the apparatus incorporates an actioning part that provides means for invoking data processing means configured to manipulate any given proxy asset or one or more data portions referenced by that proxy asset.

The information content of a library is generally regarded as being comprised of information assets, where an information asset is some piece of information that comprises a meaningful whole.

A key feature of this invention is that the information content of the library is represented by means of proxy information assets. A proxy asset does not directly contain any of the data contained within the corresponding information asset, but instead contains metadata that references an ordered plurality of data portions, where each data portion contains part of the information content of that information asset. The information contained within any one data portion need not comprise a meaningful whole, but the plurality of data portions referenced by a proxy asset, when combined in the order determined by the metadata in the proxy asset, together form a meaningful whole that corresponds to an information asset of the library. In addition, the proxy asset contains metadata identifying and optionally classifying the proxy asset.

The library may contain a proxy asset corresponding to some information asset, while also containing other proxy assets corresponding to meaningful sections of that information asset. In this case, each proxy asset corresponding to a meaningful section references, in a specific order, one or several of those data portions referenced by the proxy asset that represents the whole information asset. A section may be meaningful if it corresponds to a logical section within the information asset, or if it corresponds to an excerpt of personal interest to a user.

This representation allows a logical section within an information asset to be modelled by adding a new proxy asset rather than by changing an existing one. This is in contrast to conventional systems where an information asset is represented by a single, self-contained information unit, and a logical section within that unit is identified by means of tags or other control characters inserted amongst the information within that unit. The representation used by this invention therefore enables logical structure within a library to be refined over time without affecting existing data or existing operation of the library.

The structuring part of the invention retrieves selected information assets of the library and presents them in the structure described above. A library system designed to be an embodiment of this invention will most likely contain information stored as data portions, with appropriate metadata structured to capture the relationship between proxy assets and data portions. Alternatively, an embodiment of the invention may be integrated into an existing conventional digital library, in which case the structuring part of the Invention processes conventionally stored data into the appropriate structure during retrieval.

An advantage of the invention is that data portions may reflect the modularity of the physical medium from which the information originated, rather than any inherent modularity in the information content. This allows the library provider to choose data portions that are fastest and cheapest to process into electronic form from their physical source. For example, information originating from a paper-based source could have data portions each representing the information contained in a single physical page. An embodiment of the invention may therefore be deployed much more cheaply than one in which each information asset must first be converted into a self-contained electronic form.

The structuring part of the invention may include a display part that enables a user to interact with the proxy asset metadata and any of the data portions referenced by the proxy asset. In some embodiments, a user need not be aware that the asset is a proxy one; for example with an appropriate interface a user paging through an electronic document might be unable to detect that it is a proxy document referencing a plurality of single page files rather than a true multi-page document.

It will be appreciated that, since proxy assets may reference a subset of the data portions referenced by other proxy assets, there is an implicit hierarchy between proxy assets. Proxy assets may therefore be assigned to nodes within a normal library catalogue or classification hierarchy.

The sectioning part of the invention provides means for a user to create a new proxy asset that represents an excerpt from an information asset of the library. Such a proxy asset may be a private excerpt, representing the temporary personal interests of a user, or it may become a permanent, public part of the library, representing a logical section within the information asset.

In a possible embodiment of the invention, the sectioning part may provide means for a user to create a permanent, personalised list of excerpts, similar to a reference notebook.

In another possible embodiment of the invention, the sectioning part may provide means for an administrative user to Improve the library after deployment, by creating new, permanent proxy assets to capture increasingly refined logical sections within the information assets of the library. If an embodiment of the library is designed to use whatever proxy assets are available at any time, then systematic application of the means of the sectioning part will gradually increase the efficiency of the library system.

In an appropriate embodiment of the invention, the sectioning part may help end users of the library cope with any initial lack of structure in the data, as users may themselves identify logical sections within an information asset that do not yet have a corresponding proxy asset.

In an appropriate embodiment of the invention, the display and sectioning parts may provide means for a user to view and identify a portion of interest within an information asset that would be too large otherwise to manipulate conveniently.

Any embodiment of the invention may additionally contain an actioning part that enables manipulation of the data portions referenced by any given proxy asset. One example is that the data portions may be merged, in the order specified by the metadata of the proxy asset, to create a conventional, self-contained information asset.

It will be appreciated that a user who has defined a proxy asset representing an excerpt from one of the library's assets may, for example, use such actioning means to create a digital file containing that excerpt.

In an appropriate embodiment of the invention, the actioning part may provide means to help an end user cope with the fact that the proxy information assets are not self-contained files, by enabling such files to be generated.

In a possible embodiment of the Invention, the actioning part may provide means to enable administrative users to generate conventional information assets from the proxy assets, to improve interoperability with or to more closely imitate the behaviour of conventional library systems.

Further aspects of the invention are set out in the appended claims, and features and advantages of the present invention will become apparent from the following description of preferred embodiments of the invention, which Is given by way of example only and made with reference to the accompanying drawings.

### BRIEF DESCRIPTION OF THE DIAGRAMS

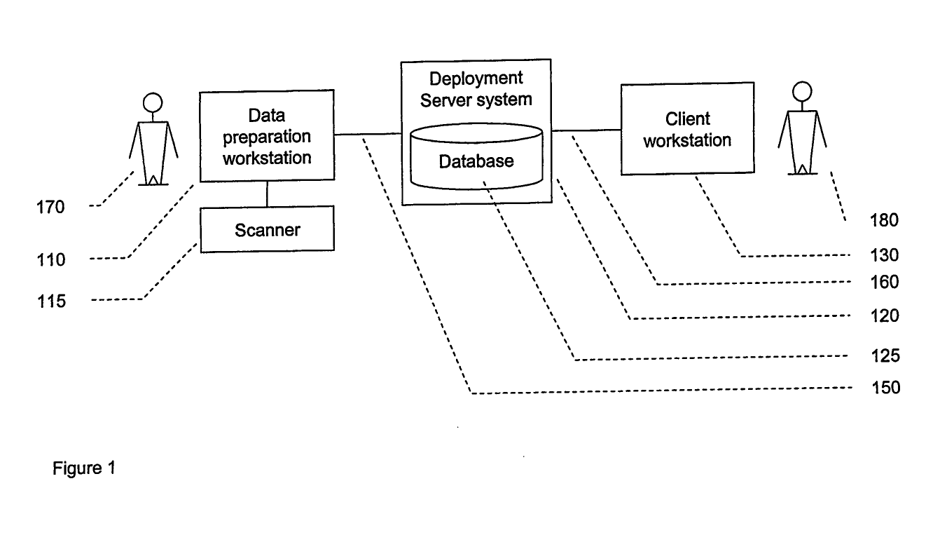

FIG. 1 illustrates an operating environment for an embodiment of the present invention;

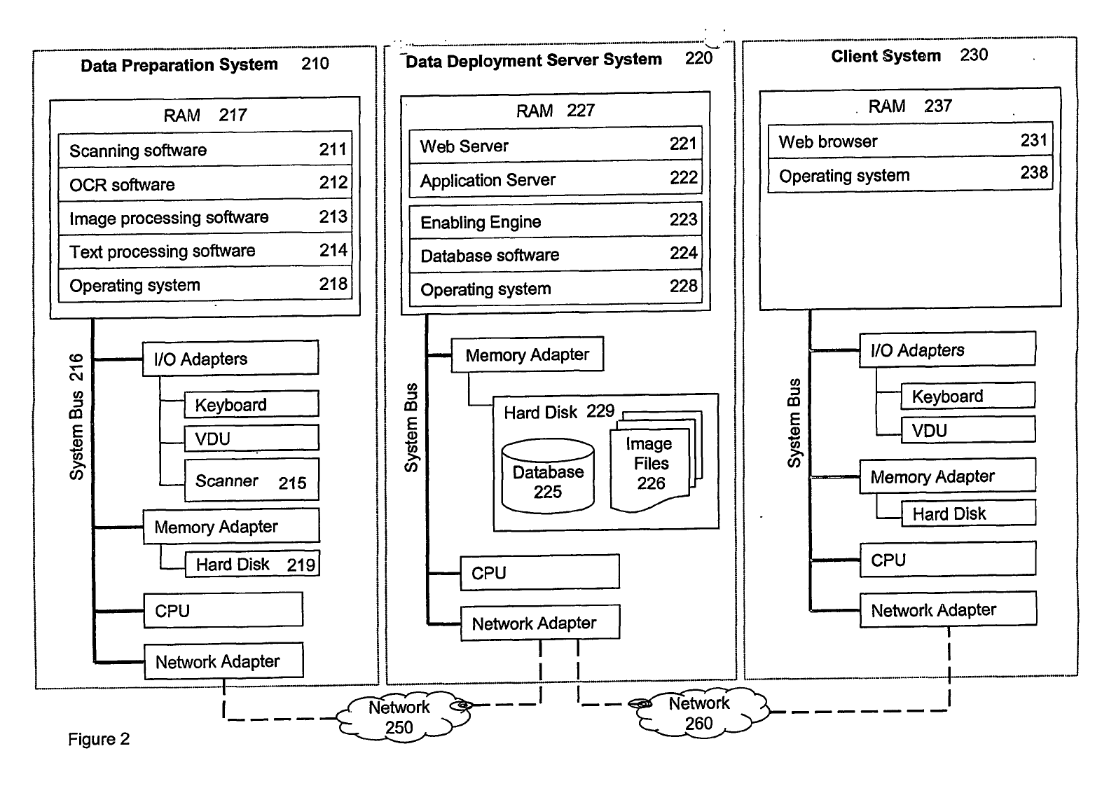

FIG. 2 illustrates the primary components of a system that operates in accordance with an embodiment of the present invention;

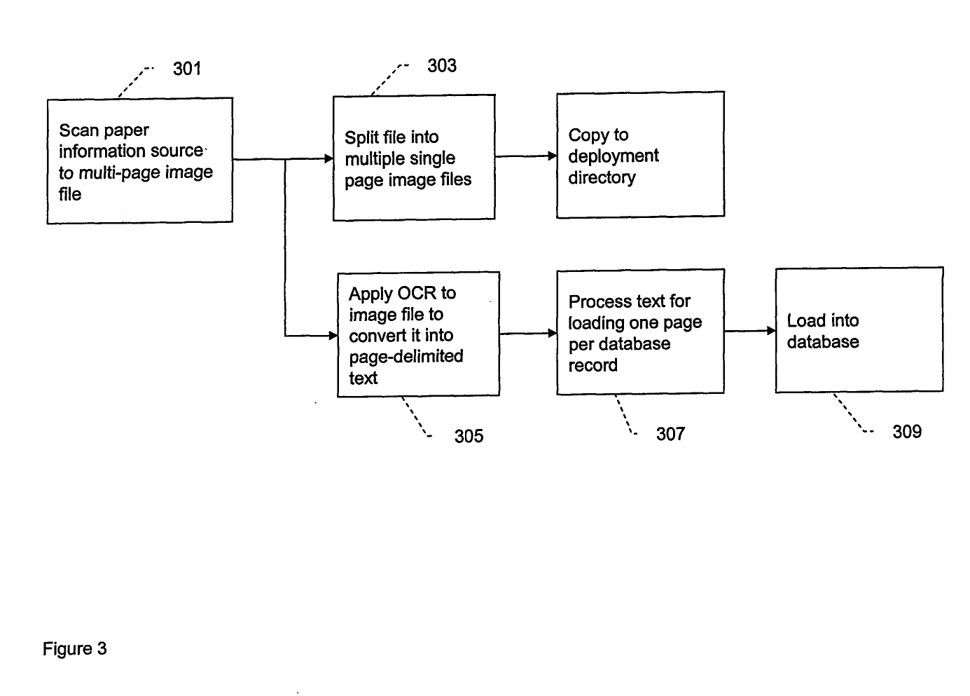

FIG. 3 is a flow diagram of the process for preparing the data according to this embodiment of the invention;

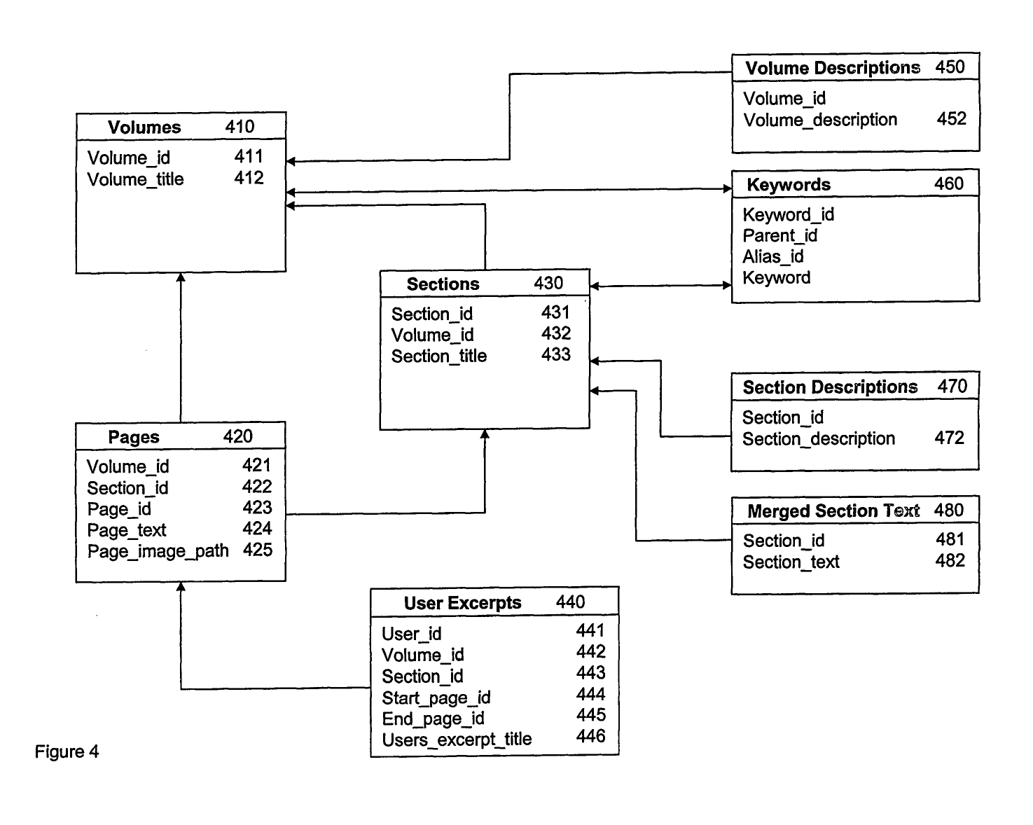

FIG. 4 is a schema diagram illustrating an exemplary database schema supporting an embodiment of the present invention;

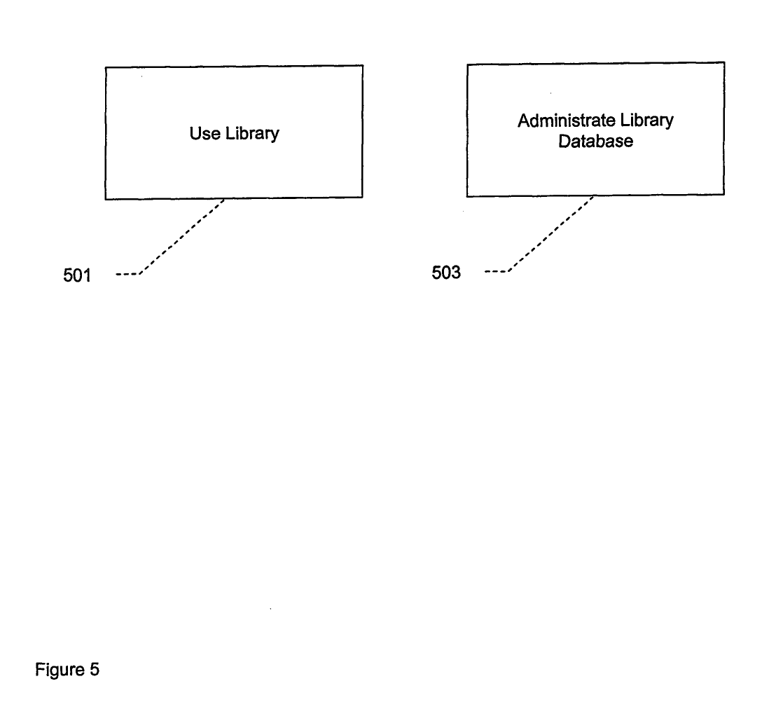

FIG. 5 is a simplified diagram of an exemplary user interface according to this embodiment of the invention;

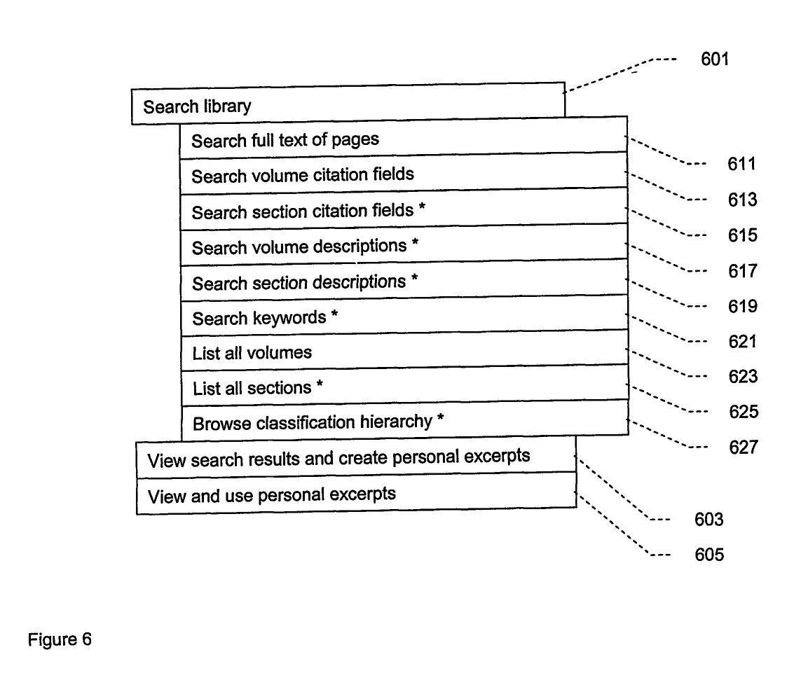

FIG. 6 is a simplified diagram of a user interface supporting the creation of personalised sections according to this embodiment of the invention;

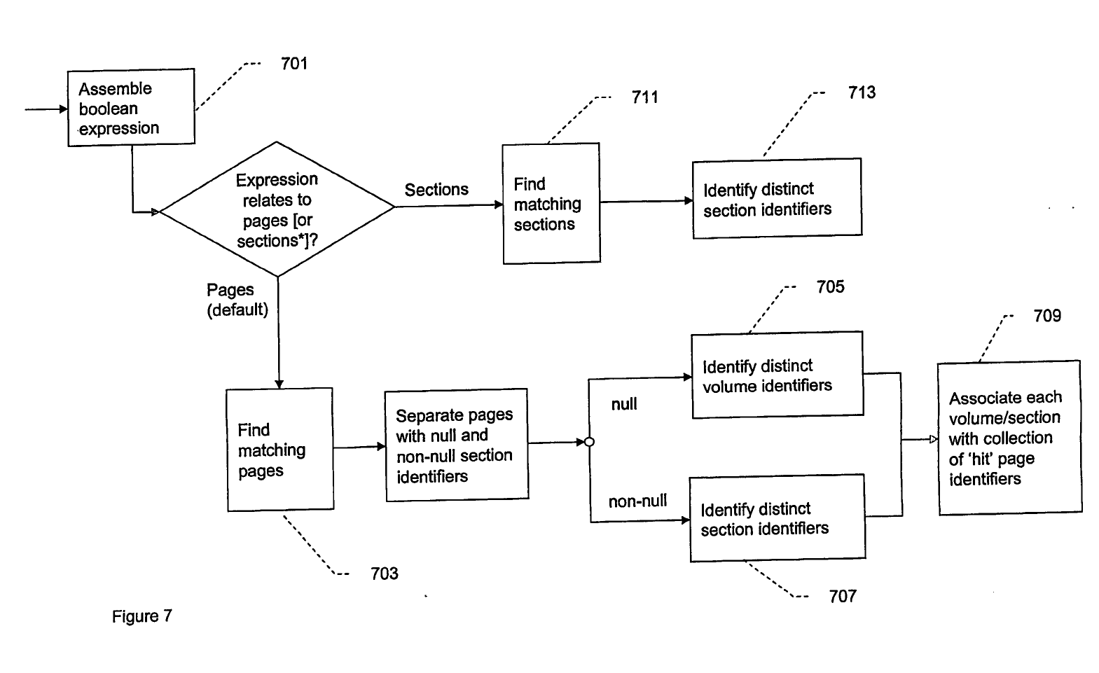

FIG. 7 is a flow diagram illustrating full-text searching according to this embodiment of the Invention;

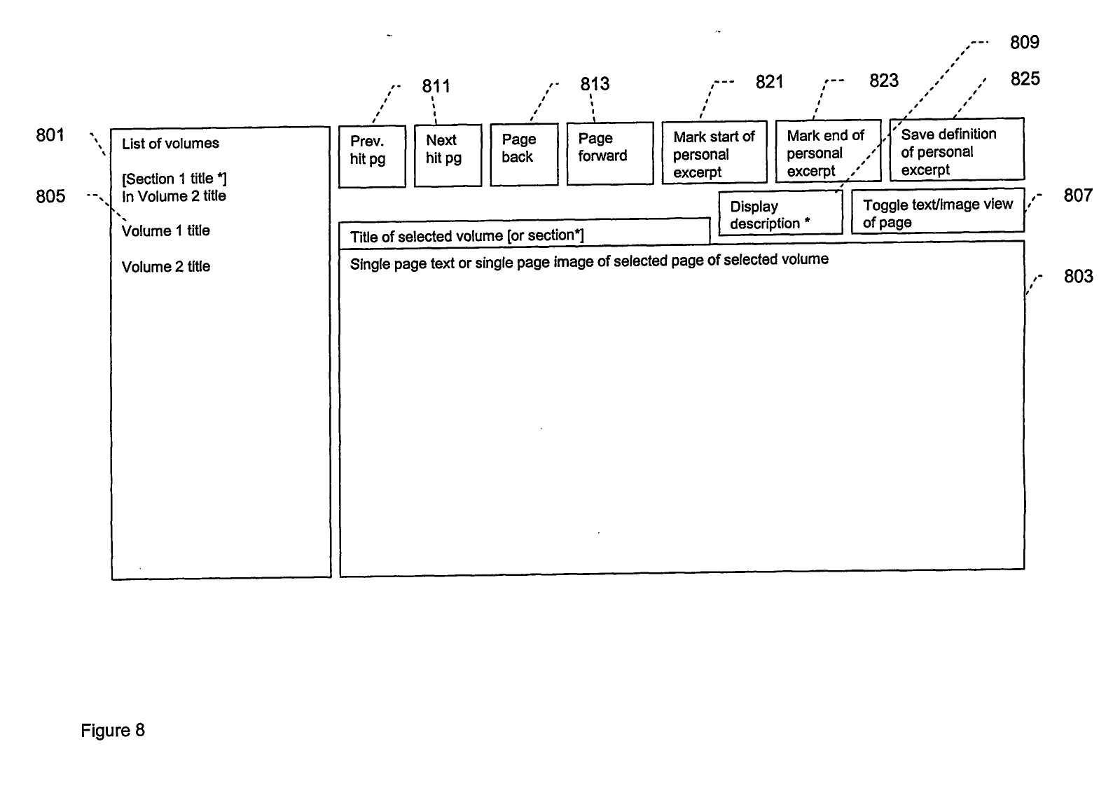

FIG. 8 shows a simplified layout for a graphical user interface for displaying and using data retrieved by a search, according to this embodiment of the invention;

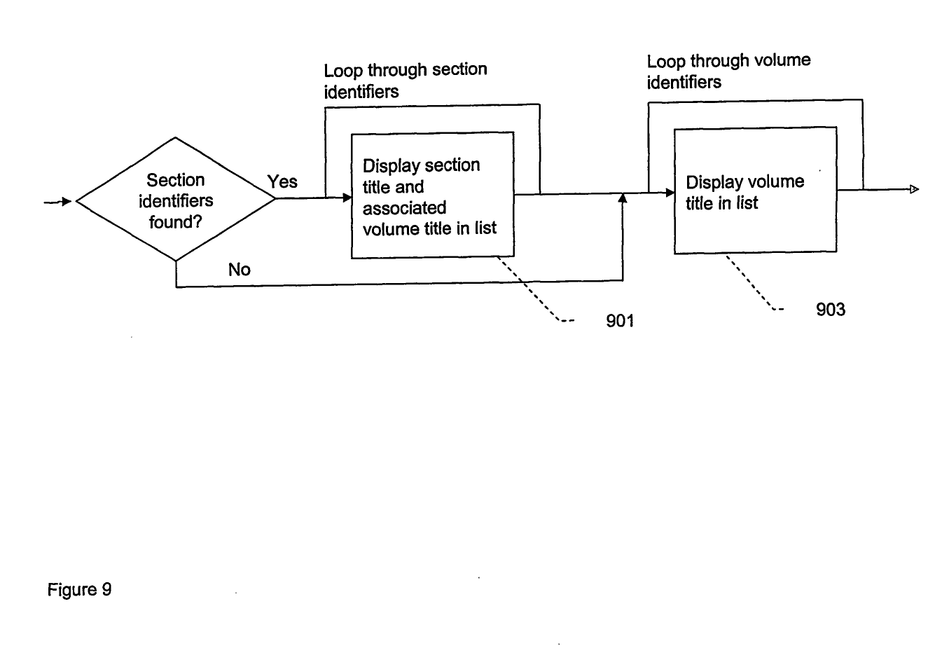

FIG. 9 is a flow diagram illustrating how the results list Is prepared according to this embodiment of the invention.

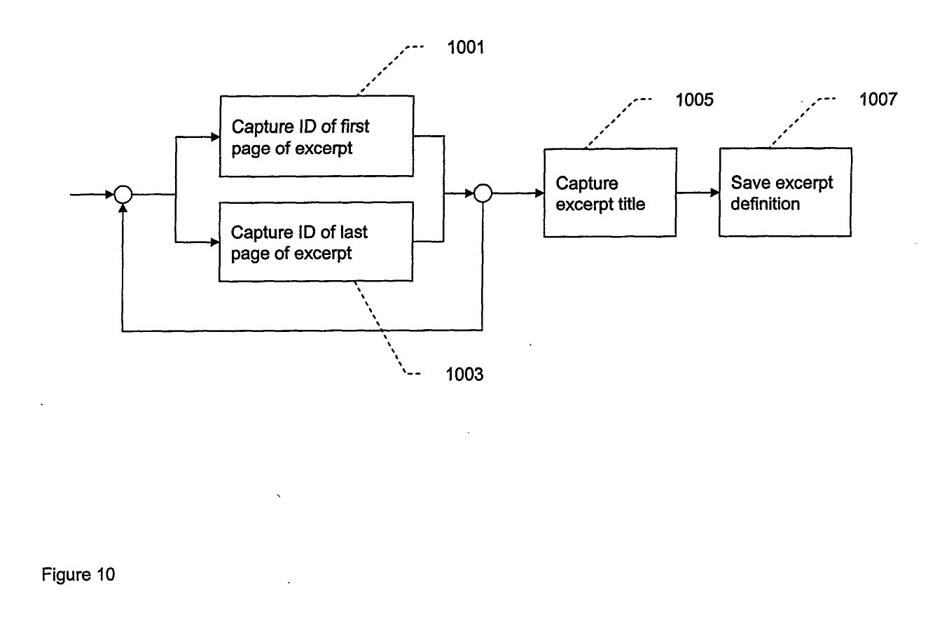

FIG. 10 is a flow diagram illustrating the creation of a personal excerpt according to this embodiment of the invention;

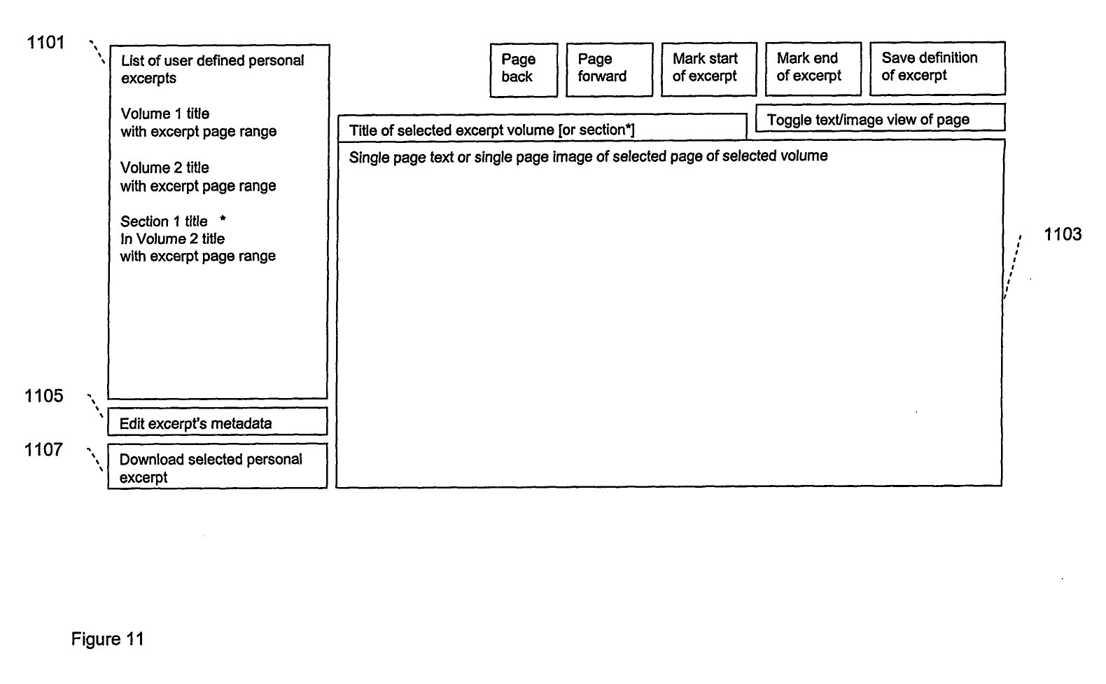

FIG. 11 shows a simplified layout for a graphical user Interface for displaying and using personalised excerpts, according to this embodiment of the invention;

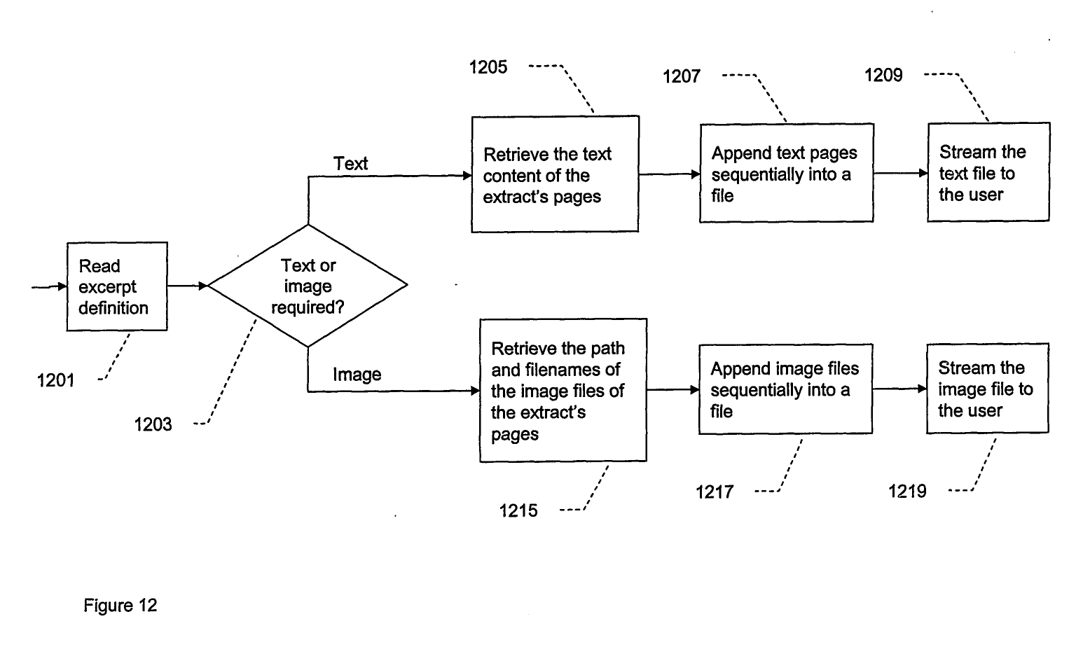

FIG. 12 is a flow diagram illustrating the process for saving a local copy of a personalised excerpt according to this embodiment of the invention;

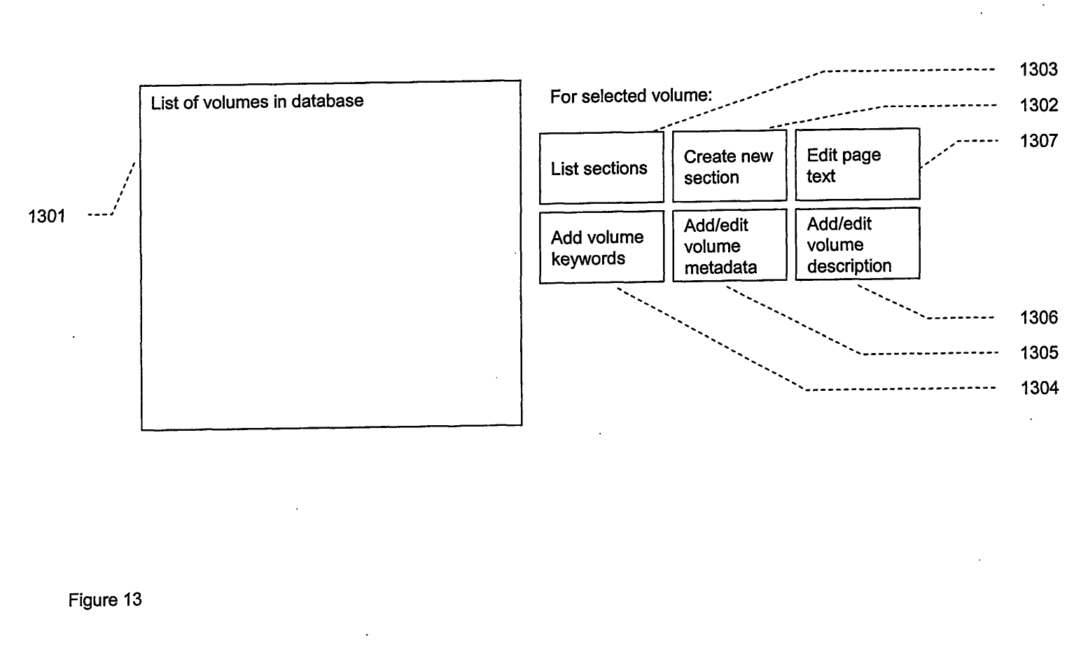

FIG. 13 is a simplified diagram of a graphical user interface for displaying volumes and enabling administration of data relating to a single volume, according to this embodiment of the invention;

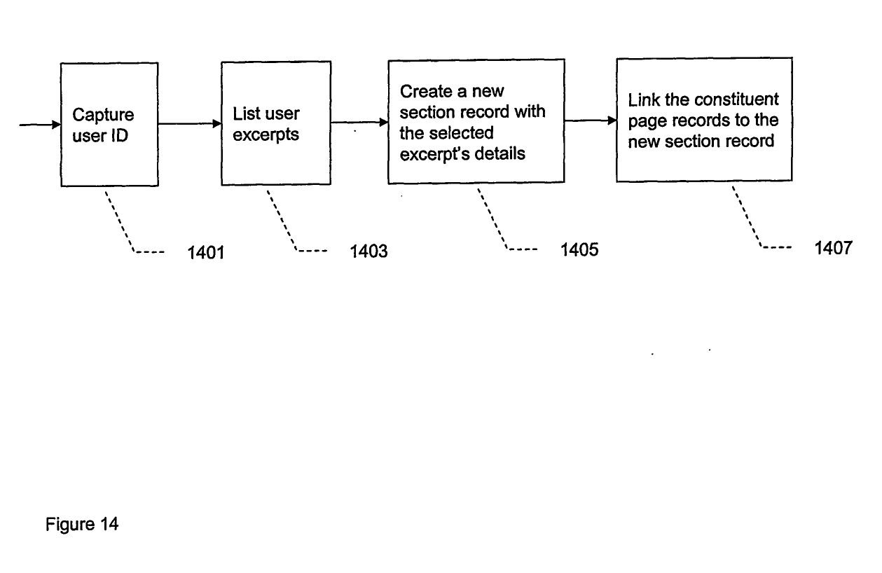

FIG. 14 Is a flow diagram illustrating the creation of a public section by a method that copies an existing user excerpt according to this embodiment of the invention;

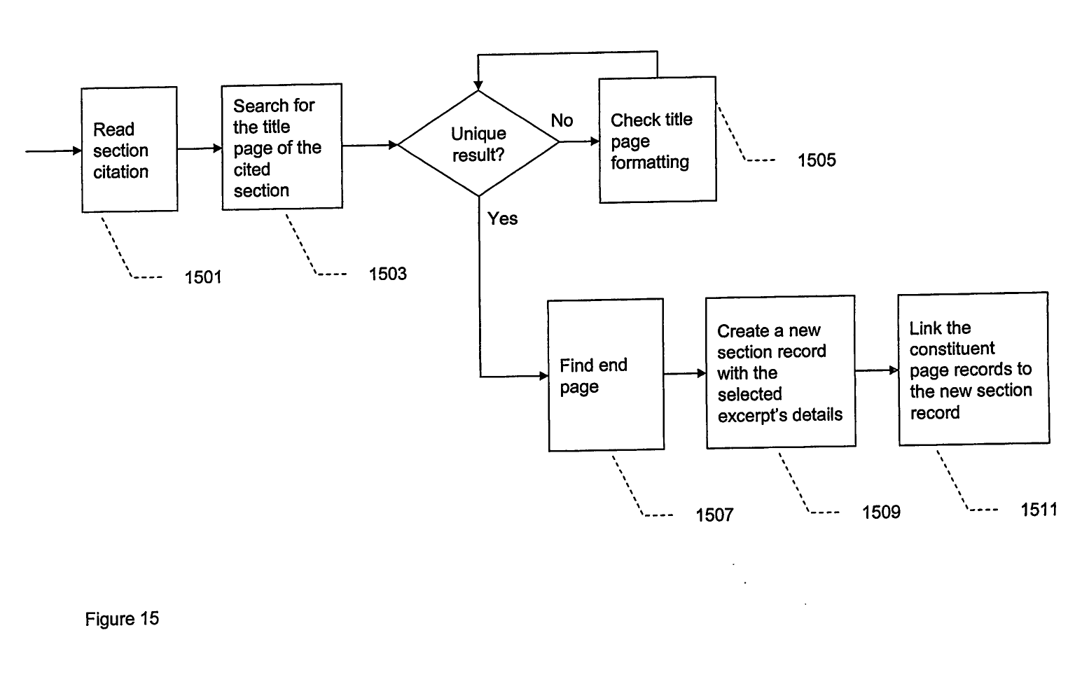

FIG. 15 is a flow diagram illustrating the creation of a public section by a method that uses given section citations according to this embodiment of the invention;

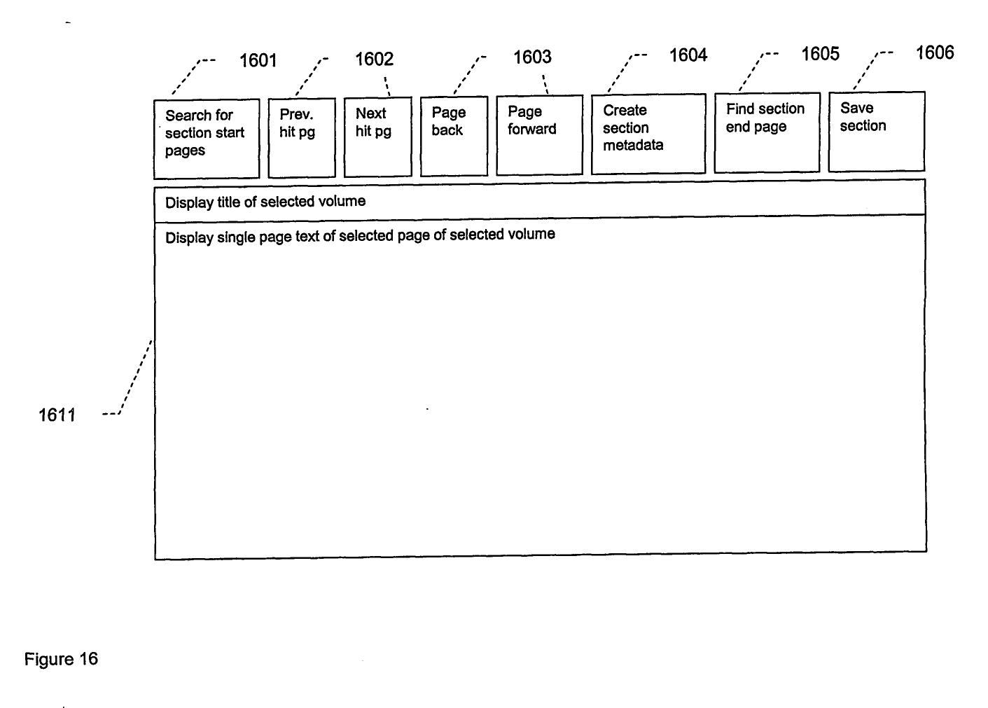

FIG. 16 shows a simplified layout for a graphical user interface to support the creation of a public section by a method that characterises the structure of title pages according to this embodiment of the invention;

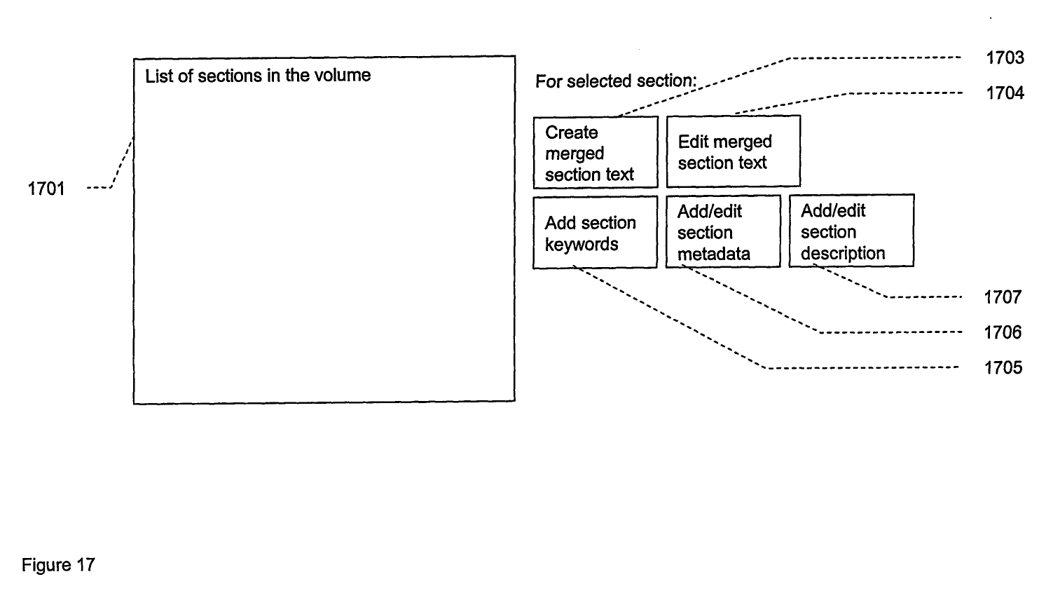

FIG. 17 is a simplified diagram of a graphical user interface for displaying sections and enabling administration of data relating to a single section, according to this embodiment of the invention.

### OVERVIEW OF THE FIRST EMBODIMENT

The first embodiment of the invention is a digital document library. Such libraries are particularly valuable for providing wide access to rare, fragile or deteriorating paper-based documents, and provide for a compact alternative to the storage of bulky paper-based records.

As indicated in the background section, the conventional process for creating a digital version of a paper-based library involves a labour-intensive preprocessing phase. Physical volumes are manually separated into logical sections; for each section descriptive metadata is keyed in, the section is scanned into an image file and optionally processed by optical character recognition (OCR) into a text file.

Although the cost of this phase is high, this approach is unsurprising since many physical volumes (e.g. journals) have a well defined logical structure (e.g. articles) and there is often little significance in the physical structure of the volume (e.g. the page breaks and the chronological sequence of articles). Each logical section has well defined metadata, comprising fields such as author details, title, abstract etc. The metadata facilitate efficient searching for an individual logical section and are important for duplicating the familiar functionality of paper library catalogues and citation indices; it is therefore conventional to identify such structure and metadata as early as possible.

In contrast to known systems, this embodiment of the invention stores the information assets of the library as data portions, where each data portion holds the information contained within a single physical paper page. Each data portion is stored in two different formats thereby capturing an image of the original physical page as well as the text content of the page.

A proxy asset is created for each physical volume to be represented in the library. As every physical page is derived from a physical volume, every data portion representing a physical page is linked to at least one set of metadata characterising a proxy volume asset. Initially, no other proxy assets are created.

In a conventional digital library, when a user has searched the library's assets and identified a logical item of interest (usually a multi-page item such as an article), the digital library software may allow the user to retrieve the item. Typically, such an item is In some file format, e.g. PDF, for which it can be assumed all users will have, or be able to obtain, appropriate viewing software. The user opens the document using that secondary software, and uses that software's internal search means to find the exact locations at which the search terms appeared.

In contrast, using the first embodiment of the invention, a search identifies individual page-wise data portions satisfying the search expression. The user is presented with a list indicative of the parent proxy volume assets rather than the Individual pages, but may view any of the single pages referenced by a selected proxy asset, including the specific pages identified by means of the search.

Using an appropriate Interface, a user may identify a range of pages of interest within any volume, and create a new, personal proxy asset referencing that excerpt from the volume.

Over time, new proxy assets may be created to represent some of the logical sections within any volume. For example, where a physical volume is a journal volume, a new proxy asset might represent an article In that volume. Where a physical volume is a book, a new proxy asset might represent a chapter in that book, or a section within a chapter of that book. A search of the library system will return the smallest of the currently available proxy assets that reference pages that meet the search criteria. Therefore, as proxy assets are added to the library, search and browse efficiency increases.

The data portions referenced by a proxy asset may be combined into a single document which may be retrieved by a user as a local file.

Alternatively, data portions within a proxy asset may be combined and stored as additional metadata for that proxy asset. Such metadata may be full-text searched in order to search at section rather than page resolution, as is the case with conventional digital library systems.

In summary, this document library embodiment initially lacks certain features of conventional digital document libraries. These absent features diminish only the efficiency of the library, and not the core capability. Volumes are not structured into their logical sections in advance, but this is mitigated by providing the end users with the ability to create virtual sections, and structure can be added over time. Citations for sections are not initially available, but full-text searching is provided as an alternative (and arguably more powerful) method for locating items of interest, and section citations can be added over time. Full text searching requires individual pages to meet the search criteria rather than whole articles, but this is a useful feature to have and whole article searches can be added over time by merging section text into new metadata. The OCR-generated text is not necessarily proofread, but the high accuracy of modern OCR software ensures that full text searching on that text will only miss a small portion of possible hits even if simple search methods are used, and results of a conventional-library standard can be obtained by using sophisticated search methods that utilise fuzzy logic, semantic processing, specialised lexicons, etc. The ability to edit text to remove such errors ensures that search accuracy can be improved over time In libraries that use simple search engines. The raw text cannot contain images, diagrams or formatting, but this is mitigated by the supplementary availability of exact images of each original page, which are available for viewing or retrieval.

Additionally, this document library embodiment has advantages over a conventional digital document library. Any user can create a personal list of reference notes and excerpts of personal relevance. The full text for large items such as books can be made available in an efficient manner, since a user can execute a search that identifies and displays individual pages of potential interest, whereas viewing an entire large item to establish its relevance would be impractical. In addition, a large document can be viewed one page at a time and short excerpts of interest downloaded. Since all physical volumes consist of a sequence of physical pages, all can be processed in a similar manner, irrespective of the nature of their content. A single library data structure can therefore contain articles, books, correspondence, book reviews, obituaries, conference reports and so forth that can all be searched simultaneously. Moreover, such an embodiment can be implemented at a fraction of the cost of a normal digital library.

### Detailed Description of the First Embodiment

The first embodiment will now be described In more detail, with reference to FIGS. 1 to 17.

System Overview

FIG. 1 illustrates a configuration and operating environment for an embodiment of the present invention. The environment comprises a data preparation workstation 110, a scanning input device 115 that is arranged to co-operate with the workstation 110, a deployment server system 120, and a client workstation 130. Links 150 and 160 may be any form of network that supports data transfer between the systems.

To initiate data preparation, a user 170 inputs the physical pages of a physical volume to be scanned to the input device 115, whereupon a digital image file is created and stored on workstation 110. The user 170 invokes various processes on workstation 110 to process the image files, whereupon the user transfers the resultant data to the server 120 and loads at least part of the data into the database 125 on server 120, in a particular format and structure to be described later.

To operate the embodiment, a user 180 working on a client workstation 130 connects to the deployment server via the network 160. The user's actions cause client processes on workstation 130 to send requests to server processes on 120 that respond by returning data that is displayed to the user.

FIG. 2 illustrates in more detail the primary components of one implementation of the environment described above. The data preparation workstation system 210 comprises a system bus 216 connecting the central processing unit (CPU), random access memory (RAM), I/O adaptors facilitating connection to user input/output devices including scanner 215, a memory adapter facilitating connection to a hard disk drive, and a network adapter facilitating interconnection with other devices on the network 250. The data preparation system's RAM 217 contains operating system software 218 which control, in a known manner, low-level operation of the workstation. The workstation includes software 211 for controlling the scanning device 215 and generating digitised images of scanned documents, image processing software 213, text processing software 214 and optical character recognition (OCR) software 212, which, as is known in the art, is for identifying text characters in an image-format computer file and generating a corresponding text-format computer file. This software is stored on the hard disk 219 and invoked via operating system processes 218 that cause them to be loaded into the computer's RAM 217. The workstation also includes client software (not shown) for remote access to the server 220.

The server 220 comprises a system bus 216 connecting the central processing unit (CPU), random access memory (RAM), a memory adapter facilitating connection to a hard disk drive, and a network adapter facilitating interconnection with other devices on both networks 250 and 260. The server RAM 227 contains operating system processes 228, database software 224, an enabling engine 223 to be described later, application server software 222 and web server software 221. The server's hard disk 229 contains the database data store 225 and various image files 226.

The client workstation system 230 comprises a system bus connecting the central processing unit (CPU), random access memory (RAM), I/O adaptors facilitating connection to user input/output devices, a memory adapter facilitating connection to a hard disk drive, and a network adapter facilitating interconnection with other devices on the network 260. The client RAM 237 contains operating system processes 238 and web browsing software 231. The structure of the network 260 is such that the web browser 231 can communicate with the web server 221 and application server 222 in the server system 220.

Setting up the Digital Library

FIG. 3 is a flow diagram of the process for preparing the data according to this embodiment of the invention. The physical pages of each physical volume are scanned 301 in sequence by scanner 215 using the scanning software 211 to produce a multi-page image of each volume (e.g. in TIFF format). The multi-page image file is then processed 303 by image processing software 213 such that each page of the physical volume is represented by a separate image file (typically PDF). Each filename contains a unique identifier that indicates its sequence in the pages of the physical volume.

Simultaneously, the OCR software 212 applies optical character recognition to the image file so as to create a page-delimited text file where each delimited page corresponds to the raw text content of a single page of the original physical volume 305. The text processing software 214 then processes 307 the text into a format suitable for loading 209 into the database 225 on server 220 such that the raw text of each page is contained within a separate record in a database table, as described in more detail later. Note that this is in contrast to conventional library systems, where a database record will typically contain the text for an entire logical unit of information such as an article representing the content from multiple physical pages.

Each individual step of the foregoing process is implemented using known commercial software and methods known in the art. The text processing software is custom written for each distinct format of physical volume, but may use unsurprising methods and algorithms. It will be appreciated that this preparation phase can be automated to a significant degree, and can thus be done in less time than the data preparation required for a conventional library system.

FIG. 4 illustrates an exemplary data schema suitable for this embodiment of the invention. The Volumes table 410 contains records that each hold the citation details for one physical volume that has been scanned and processed. Each record in the Pages table 420 contains the raw text 424 derived by OCR from a single physical page, as well as a reference 425 to the associated file containing the digital image of that physical page, where that file is stored on the server hard disk 226. Alternatively, the associated image file could be stored within the database as part of the record in the Pages table 420.

Each digital page record in the Pages table 420 contains a link 421 & 411 to the record in the Volumes table 410 that cites the physical volume from which that page was extracted. The digital page records from each physical volume are loaded in sequence, and the page identifier 423 indicates the position of any page in that sequence.

In a typical arrangement, all tables In FIG. 40 other than the Volumes 410 and Pages 420 tables are initially empty of data, and the Section_id identifier 422 is null for all records in the Pages table.

Using and Enhancing the Digital Library

The deployment server 220 includes enabling engine 223, comprising three interacting engines: a structuring engine, a sectioning engine and an actioning engine. The structuring engine provides means to select content of interest from the library and display it in a format that is appropriate to the workings of the sectioning and actioning engines, the sectioning engine provides the means for a user to create excerpts from the selected material, and the actioning engine provides means for excerpts to be processed in various ways.

Each engine comprises a plurality of software components, each of which is a computer program performing a particular function. It will be appreciated that the invention is not limited to this specific arrangement and that each component could be made up of a plurality of programs, distributed over a plurality of networked computers.

In a preferred arrangement, the enabling engine 223 receives input data and instructions in a known manner from a user's web browser 231 via the web server 221 and application server 222. The enabling engine 223 may query the database 225 via the database software 224. The enabling engine 223 may return information to the user via the application server 222 and web server 221, using known methods. Such returned information may for example take the form of an HTML user interface dynamically generated by the application server in response to instructions from the enabling engine, and transmitted to the user's web browser by the web server.

In an alternative arrangement, the client workstation 230 may incorporate a user interface process that can communicate directly with the enabling engine 223.

FIG. 5 is a simplified diagram of an exemplary top level graphical user interface for operating the enabling engine. The user selects button 501 (Use Library) in order to create and use personal excerpts. Personal excerpts are groups of pages relevant to a particular user at a particular time, and are only of interest to that user or designated others. Personal excerpts are characterised by means of metadata stored in table 440.

The user selects button 503 (Administrate Library Database) In order to create or enhance permanent, public sections. Public sections reflect an inherent logical structure within a volume, for example an article in a journal Volume or a chapter in a book, and once created are permanently accessible to all users. The public sections are characterised by means of metadata stored in tables 430, 450, 460, 470 and 480 of FIG. 4. Some of the features of the enabling engine are dependent on whether or not corresponding data are available in these tables. In the diagrams, such data-dependent features are indicated with an asterisk.

Using the Digital Library

Upon selecting button 501, the user is presented with a menu of options as illustrated in FIG. 6. Choosing option 601 enables the means of the structuring engine to search for relevant material while option 603 enables the means to display that material to the user and allow the user to create excerpts by means of the sectioning engine. Option 605 enables the means of the structuring engine to display the user's excerpts and facilitate their use by means of the actioning engine. Each option marked with an asterisk is only made available to the user if there is at least one record in its corresponding data table (the correspondences between options and data tables will be described later). Options without asterisks are always available given the initial data configuration described above.

Search Library

Selecting the Search option 601 results in a submenu of options as shown in FIG. 6. FIG. 7 is a flow diagram illustrating the action of the structuring engine after the user has selected menu option 611 (Search full text of pages). Process block 701 involves presenting an Interface to the user (not shown) whereby the user can type in or assemble a Boolean string expression characterising the desired search. By default, the search expression Is matched against each page record in the database representing to each physical page from the physical volume. The structuring engine assembles 703 a query to send to the database 225, to instruct it to search through the Page_text field 424 of the Pages table 420, for all individual pages that contain text that matches the given expression, and to return to the engine the Page_id 423, the Volume_id 421 and the Section_id 422 of matching pages.

When initially deployed, the Section_id field is null for all pages in the Page table. However, as will be described later, the sectioning engine, or some other method, may be used to create public sections representing logical groups of pages. If a page has been incorporated into such a section, the page's Section_id 422 will reference a record in the Sections table 430 via field 431, said record capturing the citation information for that section. Each page is therefore uniquely associated with a volume, and may also be uniquely associated with a section, which is itself uniquely associated with that same volume. Some of the pages matching the search expression may be associated with the same volume, and possibly also the same section.

The structuring engine separates the matching pages into two groups depending on whether the Section_id is null or non-null. For the former group, the structuring engine compiles 705 a list of the distinct identifiers of all volumes containing at least one matching page. For the latter, the structuring engine compiles 707 a list of the distinct identifiers of all sections containing at least one matching page. Each identifier, whether section or volume, is associated 709 with a collection of Page_ids representing all of the pages within the given section or volume that match the search expression.

The above database search can be limited with additional constraints in the usual manner, e.g. by constraining the values of citation fields in the Volume table such as publication year, or constraining the search to volumes Identified in the previous search, or to pages referenced in the User Excerpts table 440, which is described later.

The database schema in FIG. 4 contains a Merged Section Text table 480 that is initially empty. Authorised users may have used the actioning engine in a manner to be described later, or some other means, to populate this table with data. Each record contains, in the Section_text field 482, the full text of an entire section. If such data exists, the user interface contains a control allowing the user to specify that the structuring engine should apply the search criterion to a whole section rather than to individual pages. This corresponds to the conventional way of full text searching an electronic library.

In this case, process block 711 is activated, whereby the structuring engine assembles a query to send to the database 225, to instruct it to search through the Section_text field 482 of the Merged Section Text table 480, for all sections that contain text that matches the given expression, and to return to the engine the Section_id 481 of the matching sections. It will be appreciated that Page_ids cannot be identified under these circumstances.

Returning to the search submenu in FIG. 6, if the user selects option 613 (Search volume citation fields), the structuring engine provides an interface for capturing the user's volume search expression, which will contain a combination of requirements for the various citation fields in the Volumes table 410. The structuring engine queries the database to identify Volumes table records with fields matching the given expression.

If there is data in the Section table, the user may select option 615 (Search section citation fields). In this case, the structuring engine provides an interface for capturing the user's section search expression and identifies those records in the Sections table 430 with fields matching the given expression.

The database schema in FIG. 4 contains a Volume Description table 450 and a Section Description table 460, both of which are Initially empty. Authorised users may have used the sectioning engine in a manner to be described later, or some other means, to populate these tables with data such as abstracts for journal articles or reviews of books.

If there is data in the Volume Descriptions table, the user may select search option 617 (Search volume descriptions), in which case the structuring engine instructs the database to full-text search the Volume_description field 452 using a search string captured from the user. The process results In a list of volume identifiers indicating matching volumes.

If there is data in the Section Descriptions table, the user may select search option 619 (Search section descriptions), in which case the structuring engine instructs the database to full-text search the Section_description field 472 using a search string captured from the user. The process results in a list of section identifiers indicating matching sections.

The Keywords table 460 has many-to-many relationships to the Volumes and Sections tables, and contains keywords associated with volumes and/or sections. If there are keywords in this table, the user may select option 621 (Search keywords). The structuring engine captures a keyword from the user, queries the database to identify volumes and sections linked to that keyword, and assembles a collection of volume and section identifiers as before. There are many ways of modelling classification hierarchies in digital libraries. Any such hierarchy can be linked into the core components of this embodiment of the invention. For example, the Keywords table 460 can function as a classification hierarchy, since keywords within the table may be linked to parent keywords and keyword aliases within the same table. Option 627 triggers the structuring engine to produce a traversable tree view of keywords and their aliases by methods well known in the art, allowing volumes or sections to be identified according to their allocation in one or more classification systems.

Options 623 (List all volumes) and 625 (List all sections) trigger the structuring engine to assemble identifiers for all volumes or all sections respectively.

Various security techniques not part of this invention may be used to ensure that the engine only accesses documents that the user has permission to access.

Display Search Results

Once the structuring engine has identified a collection of section and/or volume identifiers, each one possibly having an associated collection of page identifiers, the user is returned to the menu of FIG. 6. Selecting option 603 instructs the engine to present that material to the user and to allow the user to create personal excerpts.

FIG. 8 is a simplified conceptual diagram of a graphical user interface for displaying and using the retrieved data. Area 801 Is used to display a list of the volumes or sections containing matching pages, while area 803 is used to display a single page.

FIG. 9 is a flow diagram illustrating the action of the structuring engine in populating the display area 801. By process block 901, for all identified Section_ids 431, the structuring engine lists In area 801 the corresponding section's title 433 concatenated with the title 412 of the volume to which that section belongs, said volume title identified through the linking fields Volume_id 432 and 411. Other citation details from the Section and Volume tables may be displayed with each section title.

Next, by process block 903, for all identified Volume_ids, the structuring engine appends to the list 801 each volume title 412 together with any additional desired citation information for that volume.

Each list item 805 may be associated with a collection of Page_ids 423 indicating the pages in that volume (or that section if the list item is a section) that match the search expression. The user may select any one of the list items by some means such as an adjacent button or hyperlink. If the selected item has an associated collection of page_ids, the Page_text 424 of the page with the lowest of those page ids is displayed in the area 803. If the item does not have associated page_ids, the text of the first page record in that volume (or section) is displayed.

Button 807 allows the user to switch between viewing the raw, unformatted text from the Page_text field 424, or viewing the image of that page. The page image has the advantage of being an exact reproduction of the original physical page of the physical volume. The raw page text is unformatted, may contain scanning inaccuracies, and cannot accurately reproduce any photographs, diagrams or tables that may be embedded in the source page. However, the structuring engine can highlight search terms In the raw text, and the user might be allowed to copy sections of text to the computer's clipboard for use in compiling research notes. It is therefore useful for the user to be able to choose between these two views for any page. If the button 807 is selected, the structuring engine retrieves from the database the Page_image_path 425, which specifies the path and filename to the image file for that particular page. This image file is then retrieved from that location and displayed in the area 803.

The two buttons 813 instruct the structuring engine to display the page preceding or following the current page, from the sequence of pages of the selected volume or section. In each case, a new page_id is calculated by incrementing or decrementing the current page's page_id, and the corresponding page text or image is retrieved and displayed.

The two buttons 811 instruct the structuring engine to display, if available, the previous or next page out of the list of those pages that matched the search expression and were within the selected volume or section.

It will be appreciated that since only one page at a time is retrieved and presented to the user, It is possible to deploy large volumes such as books in this manner, without the user having to retrieve the entire volume before being able to read any part of it.

Create Personal Excerpts

Buttons 821, 823 and 825 allow a user to create a personal excerpt from the selected volume, according to the process illustrated in FIG. 10. The user uses buttons 811 and 813 to navigate to the first page of the desired excerpt, and then presses button 821. The sectioning engine stores 1001 the Page_id in memory. Then the user navigates to the last page of the desired excerpt and presses button 823, whereupon this Page_id is also stored 1003 in memory. If the user then presses button 825, the user is offered 1005 an interface (not shown) for typing in personal metadata for the excerpt, e.g. a title. The sectioning engine instructs 1007 the database to insert a new record in the User Excerpts table 440 containing the user's User ID 441, the volume ID 442 and any section ID 443, the excerpt's first page ID 444 and last page ID 445, along with additional metadata fields, e.g. the excerpt title in field 446.

Alternatively, with appropriate modifications to the User Excerpts table, a single user excerpt could reference multiple distinct page ranges within a volume.

It will be appreciated that the user except could be simply a group of pages containing information that is temporarily of interest to the user. It could also correspond to a logical group of pages, e.g. an article in a journal volume, where that logical group has not yet been captured as a public section in the Section table 430. It will be appreciated that, in this way, the facility for the user to make personal excerpts mitigates against any initial lack of structure In the way volumes are stored.

Display and Use Personal Excerpts

Selecting menu option 605 instructs the structuring engine to display all of a user's personal excerpts. FIG. 11 is a simplified conceptual diagram of a graphical user interface for displaying and using personalised excerpts. Area 1101 is used to display a list of volume titles, or section plus volume titles, derived from data in table 440 processed as described above with reference to FIG. 9. Each list item additionally displays the excerpt page range and metadata such as the personal excerpt title 446. A page of a selected excerpt is displayed in area 1103, and the user may page forwards and backwards within the excerpt, and change the view format of any page, as before. The user may also create an excerpt of the excerpt, by the method described above. Pressing button 1105 invokes a dialogue box (not shown) where the user may view and edit the metadata describing this excerpt.

The user may press button 1107 to save the contents of a selected excerpt as a local computer file, by a process illustrated in FIG. 12. The actioning engine retrieves 1201 the volume_id 442, start_page_id 444 and end_page_id 445 from the User Excerpts table 440. The user specifies 1203 whether the excerpt is required as raw text or as an image document. If raw text is required, the actioning engine retrieves 1205 the Page_text 424 from the Page table for each page with the given Volume_id and with Page_id between the excerpt's start and end page IDs. The pages of text are joined in sequence 1207 into a single document, and an external module not part of this invention is invoked to stream 1209 the document to the user's computer. If an image document is required, the actioning engine retrieves 1215 the path and filename 425 for the image files of each page in the excerpt and invokes external modules not part of this invention to merge in sequence 1217 the separate image files into a single multi-page image file and stream 1219 it to the user.

Various alternative processing options may be applied to an excerpt by means of the actioning engine, for example statistics such as word count or word distribution can be computed, the excerpt can be passed to an external module for translation into another language, or an Internet search can be triggered using high-prominence terms detected in the extract.

Administrating the Digital Library

Returning to the main user interface In FIG. 5, users with appropriate authorisation may select the option 503 to administrate the database supporting this embodiment of the Invention, and in particular to create public sections. Upon selecting 503, the user is presented with a user interface represented by the simplified conceptual diagram in FIG. 13. Area 1301 is populated with a list of the titles of all volumes in the database, extracted from the Volume table 410 by means of the structuring engine. The user can select a particular volume from the list, whereupon the illustrated buttons become selectable.

Create New Public Section

If the user presses button 1302 (Create new public section), the sectioning engine allows the user to choose one of the available methods for creating a new section according to the invention. Three alternative methods are described below, by way of example.

The user may invoke a method that copies an existing personal excerpt, as illustrated by FIG. 14. In this case, the sectioning engine presents 1401 to the user a text box (not shown) in which the user can type in an identification to indicate another user whose personal excerpt is to be copied. The sectioning engine lists 1403 all excerpts defined for the selected volume by the given user, as defined in table 440. If the user selects an excerpt and confirms the section creation, the sectioning engine instructs 1405 the database to insert a record into the Section table 430 under a new Section_id 431, said record containing the current volume's Volume_id and the personal excerpt's title 446 as the Section_title 433. The sectioning engine then instructs 1407 the database to update the Section_id field 422 in the Pages table 420 so that it equals the newly created Section_id for all pages with Page_ids between the personal excerpt's start 444 and end 445 pages.

Alternatively, the user may invoke a method that uses given section citations, illustrated by FIG. 15. The sectioning engine reads 1501 a section title, author and number of pages from a previously created file or database table. It instructs 1503 the database to search the Page_text field 424 of records in the Pages table 420 belonging to the selected volume, that have not already been assigned to a section, for pages containing the author's name and title text. Information about the format of the title page may be used to ensure a unique page is identified 1505. The sectioning engine stores the page identifier and calculates 1507 the last page of the section using the given number of pages. The sectioning engine instructs 1509 the database to insert a new record containing the section title into Section table 430, with a new Section_id 431. The sectioning engine then instructs 1511 the database to update the Section_id field 422 in the Pages table 420 to equal the newly created Section_id for all pages between the section's start and end pages.

Alternatively, the user may invoke a method that recognises title pages. FIG. 16 is a simplified diagram of a graphical user interface to support this method. If the user presses button 1601, the sectioning engine presents an interface (not shown) into which the user types a Boolean expression representing a text pattern that is known to appear on all section title pages in that volume, e.g. the string ‘pp.’. The sectioning engine Instructs the database to search the Page_text field 424 of records in the Page table 420 belonging to the selected volume, that have not already been assigned to a section. The sectioning engine stores the identifiers of matching pages and displays the first such page in area 1611. The user may navigate through these title pages using the buttons 1602. For a displayed title page, the user may press button 1604, whereupon the sectioning engine provides an interface for the user to type in citation metadata for the section beginning with that page. Alternatively, the sectioning engine can call an external module not part of this invention to extract the title, author and number of pages in the section from the title page text. Such modules are known in the field of string manipulation and are the focus of ongoing development. If the user then presses button 1605, the sectioning engine invokes a method to find and display the last page of the section starting with that title page. This may involve using the number of pages in the section, as extracted from the title page, to calculate the end page, or simply moving to the page prior to the next section title page. The user confirms the section details by pressing button 1606, whereupon the section title and other citation metadata is Inserted into the Section table 430 as a record with a new Section_id 431. The sectioning engine then updates the Section_id field 422 in the Pages table 420 so that it equals the newly created Section_id for all pages between the section's start and end pages.

Other Volume Functions

With a volume selected, the user may also press button 1305 to add or edit volume citation metadata. The actioning engine captures such information and instructs the database to update the appropriate records in the Volume table 410. The user may press button 1306 to add a new record to the Volume Descriptions table 450, or to edit an existing record. Button 1304 invokes a process that allows the user to assign keywords from the Keywords table 460 to this volume, or to add new keywords to the Keywords table. Button 1307 invokes a user interface allowing the user to search or browse through individual pages within the volume, where each page is displayed in an editable window. The user may make changes to the page text, for example to correct OCR errors or to enhance the text display by adding HTML formatting, and instruct the actioning engine to update the corresponding record in the Pages table 420 accordingly.

Section Functions

Pressing button 1303 instructs the structuring engine to list all public sections defined within the selected volume. FIG. 17 is a simplified diagram of a graphical user interface to support the administration of public sections. The sections defined for the selected volume are listed in area 1701.

With a section selected, the user may press button 1706 to add or edit section citation metadata. The actioning engine captures such information and instructs the database to update the appropriate record in the Section table 430. The user may press button 1707 to add a new record containing a section abstract or review to the Section Descriptions table 470, or to edit an existing record. Button 1705 invokes a method allow the user to assign keywords from the Keywords table 460 to this section, or to add new keywords to the Keywords table.

Button 1703 (Create merged section text) causes the actioning engine to invoke a process to create a single searchable record containing the text of the entire section. Firstly, the sectioning engine retrieves the Page_text 424 for all pages in the selected section. It then concatenates the pages in sequence to form a single string. This is inserted as a new record into the Merged Section Text table 480 and linked to the Section table via the section_ids 481 & 431. Button 1704 invokes an interface (not shown) through which the user can edit the merged section text, whereupon the record in table 480 Is updated.

### Second Embodiment

A second embodiment will now be described, which is generally similar to the first embodiment, for which like parts have been given like reference numerals and will not be described in further detail. The second embodiment applies to a digital document library deploying documents that are already available in electronic form but where the internal logical structure of the documents has not been identified.

In this embodiment, the structuring engine splits each document programmatically into data portions. If the content is unstructured but the file is in a multi-page format, it is split into separate page-sized files using known methods. If the content and the file are both unstructured, it is split into approximate page-sized files by splitting the file at every first blank line after a suitably-sized batch of lines. If the content has some programmatically recognisable structure, e.g. an encyclopaedia, dictionary, recipe book etc, it is split such that each structural part corresponds to one data portion.

It will be recognised that the latter data portions may not be of equal size, and the size may not approximate a paper page or display page. The structuring engine displays each data portion as if it were a page (it being appreciated that a page may be larger than the display panel in the viewer, and scrollbar or zoom features can be used to enable the user to view all of the page information). Alternatively, the structuring engine includes a page server that dynamically splits these data portions into display-sized pages using known methods. These served pages may be considered virtual data portions.

Information stored in this form may be searched, displayed, sectioned, listed and processed as described above with reference to FIGS. 1 to 17.

Each original electronic document may be replaced by the corresponding data portions, or, if derived from an existing conventional digital library, it may be retained in that library. By employing the structuring engine to display the document in a form compatible with the invention, the additional features of the invention may be added to the conventional document library.

### Third Embodiment

A third embodiment will now be described, which is generally similar to the first embodiment, for which like parts have been given like reference numerals and will not be described in further detail. The third embodiment involves a more sophisticated distribution of data and engines between the hardware components of the system.

In this embodiment, the client workstation 230 includes a version of the enabling engine arranged to communicate with a local database. The workstation also includes a user interface program arranged to communicate with the remote sectioning engine 223 as well as the local sectioning engine.

The user interface can interact with the remote enabling engine, which in turn interacts with the remote database, in the manner of the first embodiment. In addition, the user interface can interact in the same way with the local enabling engine, which interacts with the local database. The user interface can cause the two enabling engines to synchronise the user's personal excerpt lists between the two databases, using known methods. The volume and section metadata and the page data and files referred to by the personal excerpts in the list are synchronised, therefore both databases contain copies of all data relating to the excerpts most recently defined by that user (or including other users if authorised). Whenever the remote database is unavailable, for example when the network link 260 is broken, the local enabling engine may still be used to search, view, excerpt and process the material that is in the local database.

In an alternative arrangement, the remote enabling engine and database may be replaced by a remote enabling application programmers interface (API) to an alternative type of digital library not implemented according to this invention. The API allows the local enabling engine to search, display, section and process data from the alternative library, in the manner of the first embodiment. Data may be extracted from the remote library system and saved in the local database in a manner consistent with the first embodiment.

In an alternative arrangement, the local enabling engine is arranged to copy and save data relating to user extracts from multiple remote enabling engines and from multiple remote sectioning APIs. It will be appreciated that, in this case, the system comprising local interface, database and enabling engine becomes a centralised, interactive store for a user's personal excerpts taken from a multiplicity of different remote digital libraries.

Fourth Embodiment

A fourth embodiment will now be described, which is generally similar to the first embodiment, for which like parts have been given like reference numerals and will not be described in further detail.

The fourth embodiment is an internet publishing centre enabling cartoon artists to self-publish their material In a collective, themed environment. In this embodiment, a data portion corresponds to a single cartoon strip, while each initial proxy asset references all of an artist's cartoons for one year, in chronological order. Users create additional proxy assets representing, for example, cartoons on a common theme, or strips that develop a running story.

In this embodiment, an enabling engine is running on a centralised server 220. Various artists each have data preparation systems similar to 210, at which they scan cartoon strips as they finish drawing them. The strips may have varying length, may be in colour or black and white, and may have any layout. Each strip is saved as a separate image file, as described in the case of the first embodiment.

The artist may optionally OCR the cartoons to extract and store the strip text from the speech bubbles; this is a feasible technique as some OCR packages can be trained to recognise a consistent handwriting.

The server 220 runs a loading engine which interacts with the application server and web server to dynamically generate a user interface that is presented to the artist's web browser for display, where the web browser is running on the artist's data preparation system 210.

Through the loading engine interface, the artist can copy the cartoon strip image files onto the server's file system, and insert a reference to each image file as a separate strip record into a table analogous to the page table 420 in the database on the server 220. The loading interface enables the artist to additionally include the strip text that was generated by the OCR process into the corresponding strip record. Alternatively the artist may manually enter the cartoon strip's text through the user interface. Alternatively, a centralised OCR process on 220 may be invoked by the loading engine to generate strip text automatically upon loading of a new image file, and to store that strip text in the appropriate strip record in the page table.

The strip records for each artist are loaded chronologically and sequenced in that order. As each strip record is loaded, it Is linked to an annual collection record in a table analogous to the volume table 410. The strip collection record contains metadata recording the artist and year, and any other descriptive information relevant to that year's collection of cartoon strips by that artist. Note that the strip records for the various artists are stored in the same data table.

The artist or an administrator may use the means provided by the sectioning engine to create a logical section that is a subset of an annual collection, e.g. a monthly collection.

The artist additionally uses the means provided by the sectioning engine to create themed sequences of one of more cartoon strips. These may correspond to a sequence of strips telling an extended story, or to cartoons on a common subject, and may include metadata describing the theme. It will be appreciated that such themed sequences, although ordered, need not be sub-sequences of chronological collections, and may include cartoons in any specified order extracted from various annual collections. The artist's themed sequences are designated as accessible to all users of the cartoon publishing centre.

A user of the centre is a person who subscribes to the service provided by the centre, namely to be able to browse or search the database to see cartoons drawn by any or all of the participating artists. The user accesses the embodiment from a workstation similar to 230, by means of a user interface generated by means of the enabling engine 223 and application server 222, and displayed in the user's web browser. Users can browse the themed sections created by the artists, and view the image files to see the cartoons containing that text. Users can additionally search the strip text for cartoons with text containing keywords of interest.

Artists may use the means of the enabling engine to edit a common classification hierarchy and to add theme references to the nodes of this hierarchy. Users may navigate this hierarchy to see themed sequences from various artists on similar themes conveniently grouped together.

In addition, users may create personal themed collections of cartoons for future reference or to download or to share with authorised friends. These may include cartoons from any of the participating artists.

It is to be understood that any feature described in relation to any one embodiment may be used alone, or in combination with other features described, and may also be used in combination with one or more features of any other of the embodiments, or any combination of any other of the embodiments. Although the preferred embodiments of the present invention have been described and illustrated in detail, it will be evident to those skilled in the art that various modifications and changes may be made thereto without departing from the spirit and scope of the invention as set forth in the appended claims and equivalents thereof.

1-97. (canceled)

98. A digital library system for enabling access to information, the digital library system comprising:
a structuring part that provides means for representing information assets of said digital library system with a collection of at least one proxy assets; and
a sectioning part that provides means for creating new proxy assets.

99. The digital library system as set forth in claim 98, wherein said proxy asset further comprising metadata that describes and references at least one data portion, wherein said data portion contains part of the information content of said information asset being represented.

100. The digital library system as set forth in claim 99, wherein said each new proxy asset references at least one of said data portions referenced by a given said proxy asset.

101. The digital library system as set forth in claim 100, wherein said new proxy asset created by said sectioning part represents a logical section that exists within the information content represented by said given proxy asset, and said metadata for said new proxy asset may include a citation for and a description of said logical section.

102. The digital library system as set forth in claim 101 further comprising means to progressively refine the logical structure of said digital library by enabling the systematic iterative creation of logical proxy assets and the storage of information characterizing these new proxy assets in a repository of said digital library system.

103. The digital library system as set forth in claim 100, wherein said new proxy asset created by said sectioning part represents information content of relevance to a specific user, and said metadata for said new proxy asset identifies the creating user and in addition include information provided by said user to characterize an aspect of said information content.

104. The digital library system as set forth in claim 99 further comprising an actioning part that provides means for invoking data processing means configured to manipulate any given proxy asset or said data portions referenced by that proxy asset.

105. The digital library system as set forth in claim 104, wherein said data processing means is configured to sequentially join said data portions referenced by said proxy asset into a new temporary data portion.

106. The digital library system as set forth in claim 105 further comprising means to create additional metadata for the given proxy asset by storing in a repository of said library system the text present in said temporary data portion as additional metadata of said proxy asset.

107. The digital library system as set forth in claim 106 further comprising means for enabling the systematic iterative creation of textual metadata corresponding to the combined text information referenced by each of the proxy assets in a selected batch of proxy assets and the storage of this metadata in a repository of the library system.

108. The digital library system as set forth in claim 104 wherein said data processing means is configured to enable alteration of any data portion selected from those referenced by the given proxy asset.

109. The digital library system as set forth in claim 108, wherein said alteration enables quality-enhancing editing of the information content represented by any data portion.

110. The digital library system as set forth in claim 104 wherein said alteration is configured to enable the replication, in an additional format, of the information content referenced by the given data portion.

111. The digital library system as set forth in claim 110 further comprising means for enabling systematic iterative replication of the stored content in alternative and efficient data formats.

112. The digital library system as set forth in claim 104, wherein said data processing means is configured to enable alteration of said metadata of the given proxy asset.

113. The digital library system as set forth in claim 112, wherein said metadata alteration incorporates means to edit said metadata in a way that increases its quality.

114. The digital library system as set forth in claim 112, wherein the metadata alteration incorporates means to increase the amount of metadata describing an asset.

115. The digital library system as set forth in claim 114 further comprising means for enabling the making of systematic iterative additions to said metadata contained within any of said proxy assets.

116. A digital library system for enabling access to information, the digital library system comprising:
a structuring part that provides means for representing information assets of said digital library system with a collection of at least one proxy assets, wherein said proxy asset further comprising metadata that describes and references at least one data portion, wherein said data portion contains part of the information content of said information asset being represented; and
a sectioning part that provides means for creating new proxy assets such that each new proxy asset references one or several of the data portions referenced by a given proxy asset.

117. A digital library system for enabling access to information, the digital library system comprising:
a structuring part that provides means for representing information assets of said digital library system with a collection of at least one proxy assets, wherein said proxy asset further comprising metadata that describes and references at least one data portion, wherein said data portion contains part of the information content of said information asset being represented;
a sectioning part that provides means for creating new proxy assets such that each new proxy asset references one or several of the data portions referenced by a given proxy asset; and
wherein a new proxy asset created by means of said sectioning part represents a logical section that exists within said information content represented by said given proxy asset, and said metadata for said new proxy asset may include a citation for that logical section.
